(19) United States
(12) Patent Application Publication
(10) Pub. No.: US 2008/0274559 A1
(43) Pub. Date: Nov. 6, 2008

(54) Gas Sensor for Determining Ammonia

(76) Inventors: Maximilian Fleischer, Hohenkirchen (DE); Hans Meixner, Haar (DE); Roland Pohle, Herdweg (DE); Kerstin Wiesner, Putzbrunn (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/629,550

(22) PCT Filed: Jun. 13, 2005
(86) PCT No.: PCT/EP2005/052711

§ 371 Date: Dec. 14, 2006

(30) Foreign Application Priority Data
Jun. 14, 2004 (DE) 10 2004 028 701.5

(51) Int. Cl. G01N 27/00; B01J 19/00

(52) U.S. Cl. 436/113; 422/98

(57) ABSTRACT

The invention relates to a gas sensor which is used to detect ammonia by detecting and evaluating conductivity variations on semi-conductive metal oxides, comprising: a substrate, a gas sensitive layer made of a semi-conductive metal oxide, a catalytic filter which is disposed in front of the metal oxide, said filter being used to convert ammonia, contained in the measuring gas, into a NO/NO2 mixture or to only NO2, measuring electrodes which are arranged on the surface of the substrate in order to detect conductivity variations in the semi-conductive metal oxide which is at least sensitive to NO/NO2, a controllable electric heating device which is used to adjust predetermined temperatures at least for the semi-conductive metal oxide, whereby the formed NO/NO2 can be guided to the metal oxide and the content of ammonia in the measuring gas can be determined from the NO/NO2-measurement by means of the semi-conductive metal oxide.

The invention relates to a gas sensor for reliable detection of ammonia in the typical concentration range of 1-100 ppm in air or in lean combustion exhaust gases.

Ammonia is a pungent smelling, caustic gas that is life-threatening at higher concentrations (MAC value 50 ppm; >6,000 ppm results in death within a few minutes). Ammonia/air mixtures in the range 15-28 Vol. % ammonia are explosive.

Ammonia can occur in large quantities as a pollutant emission in the case of fertilizer production and in livestock farming and slurry processing. Ammonia monitoring is necessary in these areas for the purposes of maintaining clean air and ensuring occupational safety.

Moreover, since the ban on CFC-containing refrigerants, ammonia is being used increasingly in refrigeration systems, such as for example in the foodstuffs industry or chemical industry and also in sports complexes. Leakage monitoring is also necessary in this case for the purposes of workplace safety.

Ammonia is furthermore used for reducing the NOx emission of combustion exhaust gases, and particularly for post-treating exhaust gas by using selective catalytic reduction (SCR) methods. SCR methods have been applied in the field of power stations for several years and related methods are increasingly being used in automobile engineering for the purposes of purifying diesel exhaust gas. In order to purify exhaust gas in the case of diesel engines, urea is added to the exhaust gas, which urea is converted into ammonia and carbon dioxide by means of hydrolysis. The ammonia generated in situ in this way reduces the nitrous oxides to nitrogen.

To be able to comply with the EURO-4 exhaust gas standard for buses and trucks applicable as from October 2004, SCR methods will be used for the purposes of purifying diesel exhaust gas to a greater extent in future. For safety reasons, emission of NH₃ must not be produced in the process. This has been prevented up to now by the fact that less urea is injected on average, by virtue of performance characteristic-based control, than is necessary for the complete reduction. To optimize urea dosing and minimize the safety risk of increased NH₃ emission, monitoring of NH₃ in the diesel exhaust gas is necessary. This will become a requirement for trucks as from 2008 if the more stringent demands of the new EURO-5 exhaust gas standard come into effect. Additionally, a check will be prescribed in the USA as from 2010 that is used to detect whether the driver is actually carrying urea solution or just water in the corresponding reserve container. This monitoring is to be implemented by way of brief urea over-dosing, during which an NH₃ sensor is then needed in the exhaust gas to detect the deliberately generated ammonia slippage.

For the purposes of measuring NH₃, analytical instruments based on chemiluminescence detection are primarily used at present. In the case of these instruments, NH₃ is initially converted to NO by means of a converter. Then NO is converted with ozone to form NO₂. Photons are generated during this reaction and the ammonia concentration is calculated from their intensity. These complex, costly, high-maintenance instruments are primarily used for air-quality monitoring by environmental agencies and also in the industrial domain. This technique is not suitable for mobile use.

Only low-cost, small measuring instruments or gas sensors can be considered for use in the case of diesel exhaust gas purification. In the area of NH₃ sensors, electrochemical sensors are currently offered commercially, such as for example by the company City Technologies or the company Dräger in Lübeck. These sensors are very expensive, display a limited lifetime of 2 years at most, and are not sufficiently robust for use in combustion exhaust gases.

Approaches involving the utilization of gas sensors heated to several hundred degrees Centigrade based on semi-conductive metal oxides, for example based on WO₃ and SnO₂, for the purposes of direct detection of ammonia usually fail due to the fact that metal oxides do not show a strong reaction to NH₃ and that this reaction, due to the partial oxidation of NH₃ taking place at the surface, accompanied by a decrease in resistance, and to NOₓ, accompanied by an increase in resistance, is not unambiguous and stable. In addition, sensors of this type display a selectivity that is frequently insufficient for combustion exhaust gases due to distortion of the measurement signals by HC components, and also an insufficient stability, which is mostly manifested in irreversible damage by exhaust gases.

Furthermore, the possibility exists in principle of detecting ammonia by determining the typical IR adsorption for the gas. To do this, the optical extinction characteristic of the gas is determined in the form of spectral lines. However, suitable wavelength-controllable light sources are only available, in the form of low-cost devices that can be operated at room temperature, in the NIR range (<3 μm wavelength). Absorption lines of NH₃ lying in this spectral region are very weak, however. Consequently, an optical pathway with a length of more than a meter, which is not easy to handle for many applications, is needed for detection of NH₃ in the relevant concentration range, with the result that this detection method also suffers from fundamental weaknesses.

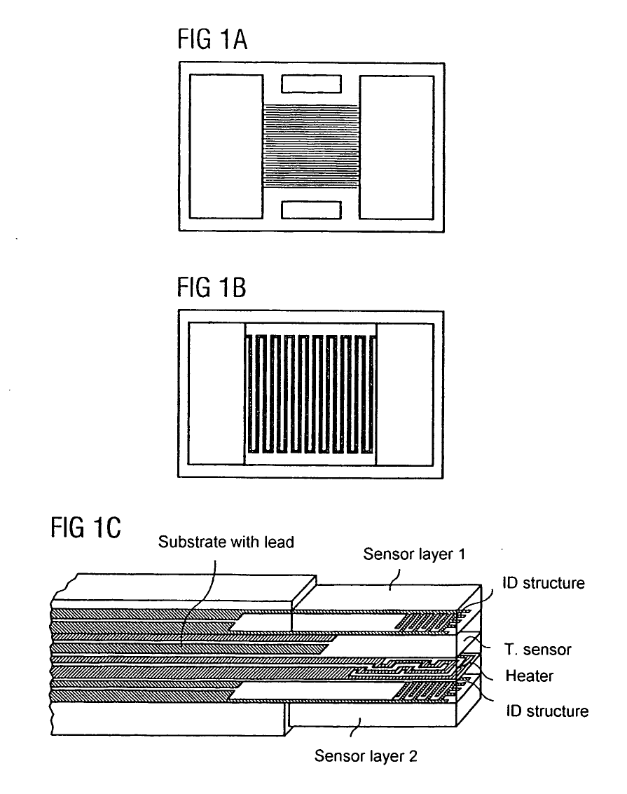

FIGS. 1A-1C show a basic structure of a sensor based on semi-conductive metal oxides according to the state of the art. Based on an electrically non-conducting, thermally stable substrate, such as for example Al₂O₃ ceramic, it contains heating structures for thermally regulating the measuring head/sensor to a specific temperature, an electrode structure for measuring the electrical resistance of the sensor layer, and also the layer of semi-conductive gas-sensitive material applied on the electrode structure.

FIGS. 1A and 1B show a miniaturized sensor chip for operation with ambient air. The front and rear sides of the sensor chip are illustrated. The chip is suspended on wires in a thermally insulated manner.

FIG. 1C shows a mechanically robust variant for use in strongly flowing combustion exhaust gases. Only the sensor tip located on the right of the figure is heated, the major part of the ceramic substrate serves as a robust holder for the structure.

The object underlying the invention is to provide a sensor for detecting ammonia that delivers reproducible measurement signals, can be produced at low cost, and is resistant to environmental influences. Furthermore, it is intended to disclose an operating method that takes account of characteristic properties and/or reactions of ammonia.

This object is achieved by means of the corresponding combination of features of claim 1, 17 or 19. Advantageous embodiments can be taken from the subclaims.

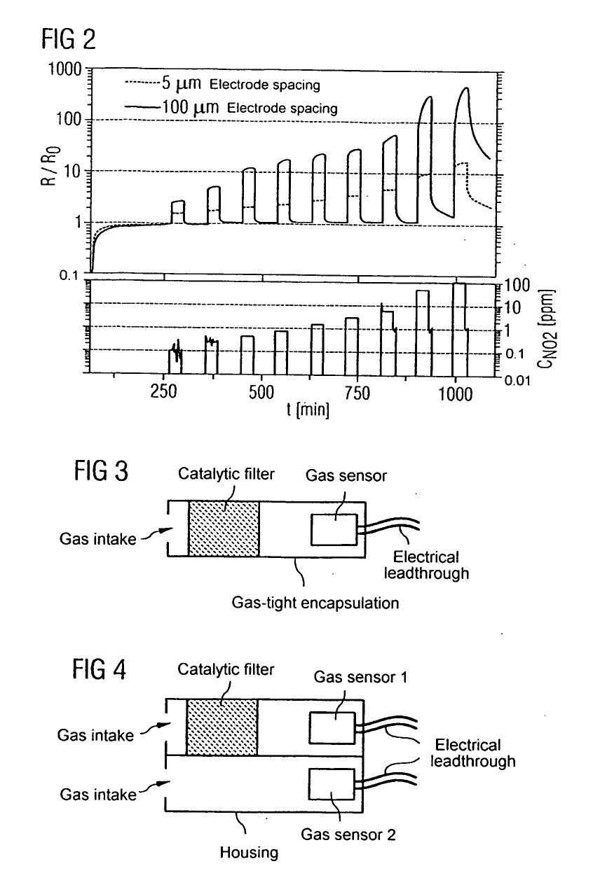

While the accuracy of direct detection of NH₃ with metal oxide gas sensors is mostly unsatisfactory, since it is attended by low sensitivity and selectivity, nitrous oxides can be detected with a high level of accuracy with sensors based on semi-conductive metal oxides. Suitable sensors, as represented in FIGS. 1A, B and C, display very high sensitivities that can be readily evaluated, i.e. changes in electrical conductivity when the target gas (NOₓ) is present with the result that even the range of small NOₓ concentrations can be resolved with a high relative accuracy, see FIG. 2.

The mode of functioning of a gas-sensitive layer is based on changes in electrical conductivity due to adsorption of nitrous oxides or reaction of nitrous oxides at the semi-conductive metal oxide layer.

The catalyst positioned upstream of the gas sensor as shown in FIG. 3 oxidizes the NH₃ to nitrous oxides, and primarily to NO and NO₂. The mixture ratio of the two gases is defined by the temperature in accordance with a thermodynamic equilibrium and not determined by the respective catalyst material as long as said catalyst material has a strong enough effect to achieve complete conversion. The observance of a constant mixture ratio is important since the metal oxide gas sensors usually react to the two nitrous oxides NO and NO₂ with different sensitivities.

In addition, oxidation of reducing gases such as H₂ or CO or hydrocarbons is effected with the catalyst with the result that said reducing gases can no longer reach the sensitive material and cause an incorrect indication.

A system consisting of two sensors provides that one of said sensors is provided with an oxidation catalyst as defined in the above implementation. Said oxidation catalyst therefore detects the totals of the NOₓ oxidized from NH₃ and the NOₓ possibly present additionally. The other second sensor is not provided with an oxidation catalyst and detects the NOₓ present in the measuring atmosphere. By comparing the two sensor signals, the background content of NOₓ and also the precise content of NH₃ can then be determined. An outline drawing in this respect can be found in FIG. 4.

In the following, exemplary embodiments are described on the basis of figures that are schematic and not restrictive of the invention:

FIGS. 1A-1C show a basic structure of a sensor based on semi-conductive metal oxides according to the state of the art,

FIG. 2 shows the detection of NO₂ with a sensor based on a semi-conductive WO₃/TiO₃ mixed oxide at various measuring electrode spacings,

FIG. 3 shows a diagram of the structure with deposited catalytic filter,

FIG. 4 shows a structure variant with two sensors, wherein only one is provided with a catalytic filter,

FIG. 5 shows the setting of the NO/NO₂ equilibrium with an oxidation catalyst (Al₂O₃-supported platinum, wherein the defined thermodynamic equilibrium is established at temperatures above 300° C.,

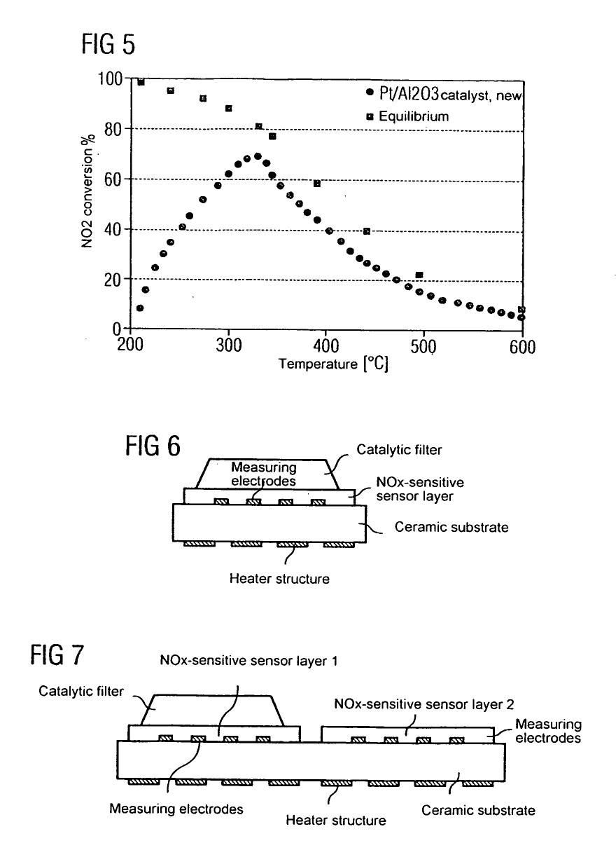

FIG. 6 shows an exemplary embodiment in which the catalytic filter is implemented directly on the gas-sensitive layer as a porous covering layer,

FIG. 7 shows an exemplary embodiment for a two-sensor system in which the catalytic filter is implemented directly on the gas-sensitive layer as a porous covering layer on one sensor, and a second sensor detects the NOₓ component before the filter,

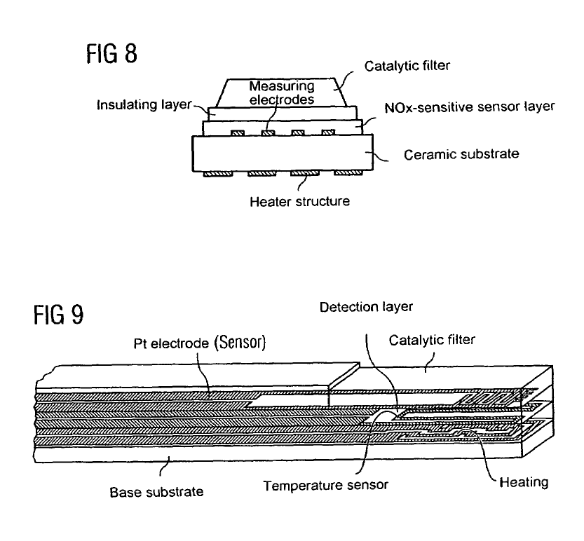

FIG. 8 shows the use of an additional insulating layer, as a result of which the electrical conductivity of the gas-sensitive material can be read out without difficulty, and

FIG. 9 shows a variant of the embodiment in a mechanically robust structure that can be used in the exhaust gas of diesel engines for example.

FIG. 2 depicts the basis for detection of nitrous oxides, wherein the obtainable signals for corresponding NO concentrations are drawn in the illustrated graph, which signals are measured with a sensor based on a semi-conductive WO₃/TiO₃ mixed oxide, with the additional parameter of various measuring electrode spacings.

According to the invention, a sensor design is therefore proposed in which:
a metal oxide sensor is used that can detect nitrous oxides, NO and/or NO2.
the measuring gas passes through a catalytic filter (oxidation catalyst) prior to the contact with the metal oxide sensor, with which catalytic filter NH₃ is converted to an NO/NO₂ mixture in a defined manner, in this respect the catalyst being at a fixed predetermined temperature typically between 300° C. and 700° C.
the detection of the NO₂ is performed with a gas-sensitive layer made from a metal oxide which is operated at a fixed predetermined temperature typically between 300° C. and 700° C.

A corresponding schematic structure is shown in FIG. 3. The structure shows a separate catalytic filter positioned upstream of the gas sensor.

The oxidation of NH₃ at the catalyst takes place according to the following formula:

4NH₃+5O₂→4NO+6H₂O+906.11 kJ

Depending on the temperature, NO reacts further with oxygen to form NO₂:

2NO+O₂ [symbol] 2NO₂+114.2 kJ

An expansion of the procedure provides for the utilization of a two-sensor system. One sensor is provided with an oxidation catalyst as defined in the above implementation and with it detects the totals of NH₃ and NOₓ possibly present additionally. The second sensor is not provided with an oxidation catalyst and detects the NOₓ present in the measuring atmosphere. By comparing the two sensor signals, the background content of NOₓ and also the precise content of NH₃ can then be determined.

In the event that the catalytic filter displays an electrical conductivity that is so high that the resistance measurement of the actual sensor layer is thereby distorted, an additional open-pored and therefore gas-permeable electrically insulating layer is to be provided between the catalytic filter and the sensor layer.

The structure variant represented in FIG. 4 shows a system consisting of two sensors, only one of which is provided with a catalytic filter, while the other without a filter measures NOₓ components already present in the measuring gas.

In the case of the two-sensor variant, distorting influences such as e.g. zero-point drift or a temperature influence on the basic sensor resistance can additionally be eliminated during the difference generation and a stabilized signal is produced in the NH₃ detection.

Low-cost NH₃ sensors are available for the first time with which NH₃ can be measured reliably and reproducibly. As a result of the fact that ammonia is completely converted into nitrous oxides prior to the detection, the partial oxidation ceases to apply and a stable measuring signal is established.

Given suitable dimensioning, the oxidation catalyst positioned upstream will also break down any occurring hydrocarbons to their oxidation products, H2O and CO2. Since metal oxide gas sensors do not react, or only react weakly, to these substances, a possible distorting cross-sensitivity to reducing gases is thereby also eliminated.

Very robust embodiments can be realized with the principle described, with the result that measurements can also be implemented in hot diesel exhaust gases with structures of this type.

The procedure also solves a basic problem that arises during the detection of nitrous oxides by using metal oxide gas sensors: usually a mixture of NO and NO₂ is present, it being necessary to note that metal oxide gas sensors display different sensitivities to these two gases with the result that a different signal is produced at the sensor, in spite of a constant concentration of the total nitrous oxide content, corresponding to the relative proportions of the components. If the catalytic filter is utilized according to the invention, however, the thermodynamic equilibrium of NO and NO₂ determined by the temperature of the catalyst is established, that is to say a defined and constant mixture ratio of NO/NO₂ is fed to the sensor from which an unambiguous sensor signal is produced.

FIG. 5 shows a representation on the basis of which the setting of the NO/NO₂ equilibrium with an oxidation catalyst (Al₂O₃-supported platinum) can be explained. The defined thermodynamic equilibrium is established at temperatures over 300° C.; the measured NO component corresponds almost exactly to that expected theoretically. The respective component of NO is produced from the difference between 100 and the NO₂ component represented.

It is advantageous in accordance with a simple sensor structure to apply the catalytic filter directly on to the heated metal oxide sensor as a porous ceramic coating, cf. FIG. 6 and FIG. 7. As a result, the catalytic filter is held at the required predetermined operating temperature by way of the thermal regulation of the gas sensor, which temperature additionally lies close to that of the sensor element with the result that a further shift in the NO/NO₂ ratio is prevented. Moreover, a very simple structure is specified as a result.

An electrically non-conducting ceramic, e.g. Al₂O₃ or AlN, is utilized as the substrate, or a conducting substrate material, such as silicon, is utilized which is provided with corresponding insulating layers, such as SiO₂ or SiN, at the surface. The electrode structures consist of a temperature-resistant metal, e.g. platinum, gold or a metal of the platinum group. They are applied either in a physical deposition method, such as sputtering or vapor deposition, and then structured, for example by using photolithography and subsequent ion etching or directly by using laser material processing, or are structured directly by using screen printing technology.

The sensitive material is applied by using screen printing or a physical method (sputtering or vapor deposition). The catalytic filter is applied as an open-pored ceramic layer, e.g. by using a screen printing method. In the event that the catalytic filter displays an electrical conductivity that is so high that the resistance measurement of the actual sensor layer is thereby distorted, an additional open-pored and therefore gas-permeable electrically insulating layer is to be provided between the catalytic filter and the sensor layer. Said electrically insulating layer can consist of a typical catalyst support, such as e.g. Al₂O₃ ceramic, or even the basic material of the gas-sensitive layer, prepared in a form that is a poor electrical conductor by means of suitable measures, such as electrical doping or weak sintering, for the purposes of obtaining very high grain boundary resistances; see FIG. 8.

FIG. 9 specifies a particularly robust structure in mechanical respects, e.g. for use in the exhaust gas section of combustion engines.

Oxides such as WO₃, TiO₂, and also In₂O₃ have proved to be particularly suitable metal oxides for the detection of NOₓ. Mixtures of different metal oxides are preferably used, with a component of one of said materials by preference. In particular, WO₃/TiO₂ mixed oxides with a typical mixture ratio of the oxides between 10:90 and 90:10 display a sufficiently high stability in various environmental conditions.

These materials are prepared as layers, it being possible to use not only cathode sputtering and screen printing methods but also CVD methods. Typical layer thicknesses lie between 1 and 10 μm in this respect. It is particularly advantageous if a porous layer of the metal oxide is utilized.

For the purposes of converting ammonia to nitrous oxides, oxidation catalysts, preferably from the group of platinum metals, such as Pt, Pd or Rh or mixtures of these materials, or of the transition metal oxides, such as e.g. Cr oxides or V oxides, are used. These are preferably implemented as a supported catalyst, prepared by impregnating a catalyst support. Al₂O₃ for example, or even the basic material of the gas-sensitive layer, is utilized in this case as the catalyst support. Mixtures of metal oxides and platinum metals can also be used. Fine dispersions of the catalyst are primarily utilized in this respect.

The catalysts can be applied directly on to the sensor chip. Impregnation methods in which a salt of the precious metal is dissolved in a solvent wetting the surface of the metal oxide and said solution is applied to the surface of the prepared gas-sensitive metal oxide are suitable for this. After drying, the salt is then broken down chemically and the metallic catalyst cluster is formed. A very thin all-over layer of the catalyst can also be applied on the surface of the metal oxide, with a maximum thickness of 10 nm, with the aid of a PVD method (e.g. cathode sputtering). The catalyst clusters are generated in the necessary size in a subsequent heat-treatment stage with temperatures between 600° C. and 1,000° C.

Furthermore, the catalyst can be inserted into an additional filter layer that is deposited on to the actual gas-sensitive layer, for example by means of screen printing methods. In this respect, this additional filter layer is made of a material that does not display any gas sensitivity itself and is porous enough so that the gas diffusion to the sensitive layer is not hindered.

Furthermore, an oxidation catalyst can also be accommodated in a part of an overall sensor structure that is separate from the sensor chip itself. The gas flow to the sensor must then firstly pass though this equipment part. In this case, a catalyst can be inserted as a catalyst gauze for example.

1.-21. (canceled)

22. A gas sensor for detecting ammonia by capturing and evaluating conductivity variations on semi-conductive metal oxides, said gas sensor having a first sensor comprising:
a substrate;
a gas-sensitive metal oxide layer made of a semi-conductive metal oxide which is sensitive at least to NO/NO₂, such that a conductivity of the metal oxide varies in response to NO/NO₂;
a catalytic filter converting ammonia contained in a gas to be measured into an NO/NO₂ mixture or entirely to NO₂, said catalytic filter being positioned in front of the metal oxide so that the NO/NO₂ generated in the filter is fed to the metal oxide;
measuring electrodes arranged on the surface of the substrate to detect conductivity variations of the semi-conductive metal oxide caused by NO/NO₂, whereby the content of ammonia in the gas to be measured is determined from the NO/NO₂ measurement; and
a controllable electric heating device configured to set predefined temperatures at least for the semi-conductive metal oxide.

23. The gas sensor of claim 22, wherein said controllable electric heating device holds the catalytic filter at a constant temperature to obtain a defined NO/NO₂ ratio.

24. The gas sensor of claim 22, wherein said semi-conductive metal oxide contains WO₃, SnO₂, TiO₂ or In₂O₃.

25. The gas sensor of claim 24, wherein said semi-conductive metal oxide is a mixed oxide containing WO₃, SnO₂, TiO₂ or In₂O₃.

26. The gas sensor of claim 25, wherein said semi-conductive metal oxide consists of WO₃/TiO₂ mixed oxide.

27. The gas sensor of claim 22, wherein said electrical heating device is configured to heat said catalytic filter to a predefined temperature in the range 300° C. to 700° C.

28. The gas sensor of claim 22, wherein said electrical heating device is configured to heat said semi-conductive metal oxide to a predetermined temperature between 300° C. and 700° C.

29. The gas sensor of claim 22, further comprising an enclosure having a gas intake, said catalytic filter and said metal oxide are installed one behind the other in said enclosure such that said catalytic filter faces said gas intake.

30. The gas sensor of claim 22, further comprising a second sensor having a metal oxide layer exposed directly to the gas to be measured.

31. The gas sensor of claim 30, wherein said first and second sensors are accommodated in separate enclosures.

32. The gas sensor of claim 22, wherein said catalytic filter is prepared from a metal in the platinum group or an oxide of the transition metals.

33. The gas sensor of claim 32, wherein said catalytic filter is prepared from a metal consisting of Pt, Pd or Rh.

34. The gas sensor of claim 32, wherein said catalytic filter is prepared from an oxide consisting of Cr oxide or V oxide.

36. The gas sensor of claim 22, wherein said catalytic filter is prepared from a metal in the platinum group as a catalyst supported on a ceramic support.

37. The gas sensor of claim 36, wherein said ceramic support is Al₂O₃ or the material of said gas-sensitive layer.

38. The gas sensor of claim 22, wherein said catalytic filter is applied as an open-pored ceramic coating directly on said gas-sensitive metal oxide layer.

39. The gas sensor of claim 38, further comprising a gas-permeable electrically insulating layer between said catalytic filter and said gas-sensitive metal oxide layer.

40. The gas sensor as of claim 22, wherein spacings between said measuring electrodes are smaller than or the same size as a layer thickness of said gas-sensitive metal oxide layer, so that said measuring electrodes capture the electrical conductivity of essentially only said gas-sensitive metal oxide layer.

41. A method of operating a gas sensor, wherein the gas sensor includes a first sensor having a substrate, a gas-sensitive metal oxide layer made of a semi-conductive metal oxide which is sensitive at least to NO/NO, such that a conductivity of the metal oxide varies in response to NO/NO₂, a catalytic filter converting ammonia contained in a gas to be measured into an NO/NO₂ mixture or entirely to NO₂, the catalytic filter being positioned in front of the metal oxide so that the NO/NO₂ generated in the filter is fed to the metal oxide, measuring electrodes arranged on the surface of the substrate to detect conductivity variations of the semi-conductive metal oxide caused by NO/NO₂, whereby the content of ammonia in the gas to be measured is determined from the NO/NO₂ measurement, and a controllable electric heating device arranged configured to set predefined temperatures at least for the semi-conductive metal oxide, said method comprising the steps of:
varying a temperature of the catalytic filter on a cyclic basis to generate a large component of NO₂ in the lower temperature range;
collecting the generated NO₂ component at the catalytic filter by adsorption; and
desorbing and feeding the NO₂ component to the gas sensor during a subsequent temperature increase.

42. The method of claim 41, wherein temperature variations lie in the range between 100° C. and 250° C. and cycle times between 10 seconds and 1 minute during said step of varying.

43. The method of claim 41, wherein the gas sensor has a second sensor with a gas-sensitive metal oxide layer directly exposed to the gas to be measured, the method further comprising the steps of:
detecting, by the second sensor, the NOx content in the gas to be measured;
detecting, by the first sensor, the overall content of NOx and NH₃; and
using the difference or quotient generation for the two sensor signals to selectively determine the NH₃ concentration.

44. The method of claim 43, wherein cross-sensitivities such as that to oxygen and moisture affect both the first and second sensors in a comparable manner and are eliminated in the difference or quotient generation for the two sensor signals.

45. The method of claim 43, wherein drifting of the first and second sensors due to aging affects both the first and second sensors in a comparable manner and is eliminated in the difference or quotient generation for the two sensor signals.
